(19) United States
(12) Patent Application Publication
(10) Pub. No.: US 2024/0057750 A1
(43) Pub. Date: Feb. 22, 2024

(54) Roofing Nail Coil Holder Device

(71) Applicants: Bonnie Tibbs, Belfair, WA (US); Floyd Tibbs, Sr., Belfair, WA (US)

(72) Inventors: Bonnie Tibbs, Belfair, WA (US); Floyd Tibbs, Sr., Belfair, WA (US)

(21) Appl. No.: 17/937,541

(22) Filed: Oct. 3, 2022

Related U.S. Application Data
(60) Provisional application No. 63/399,292, filed on Aug. 19, 2022.

(51) Int. Cl. A45F 5/02; B25H 3/00

(52) U.S. Cl. CPC A45F 5/021; B25H 3/00

(57) ABSTRACT

The present invention relates to a novel roofing nail coil holder device. The device is a storage device designed to store nail coils for nail guns. The device comprises a tubular housing component that can store eight to ten rolls of nail coils simultaneously. Further, the front of the tubular housing component comprises a thin slot, allowing users to easily pull nail coils from the device for reloading them into the nail gun. The nail coils will be stacked vertically within the tubular housing component, thereby ensuring that the nail coils are safely stored and remain easily accessible. The rear of the tubular housing component comprises a clip that allows the tubular housing component to be secured to a user's toolbelt for easy transportation.

### CROSS-REFERENCE TO RELATED APPLICATION

The present application claims priority to, and the benefit of, U.S. Provisional Application No. 63/399,292, which was filed on Aug. 19, 2022, and is incorporated herein by reference in its entirety.

### FIELD OF THE INVENTION

The present invention relates generally to the field of roofing nail coil holder devices. More specifically, the present invention relates to an improved roofing nail coil holder device that provides users with a cylindrical storage system for nail coils. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in roofing nail coil holders. Generally, nail guns operate via coils of nails being inserted into the nail gun. These nail coils are kept in their coiled form for ease of loading and feeding into the nail gun. Thus, contractors and installers typically carry multiple nail coils with them to a worksite. However, nail coils can get smashed in a toolbelt, and some toolbelts may lack space for carrying multiple coils. Accordingly, significant time and effort can be wasted trying to unravel the nail coils and insert them into the nail gun.

Each coil of nails comprises a plurality of nails of identical size which are disposed in juxtaposed relation and maintained in this position by a succession of relatively narrow strips of paper-like material adhering to the respective nail, intermediate its ends, and/or wire collated together. The elongated strip of nails joined by the paper strips are rolled from one end to form a coil of nails. One end of these elongated strips of nails are fed into the nail gun which successively drives one of the nails into a desired structure to be nailed in response to a user actuating the nail gun. Since a nail gun rapidly uses all of the plurality of nails in a single nail coil, it is desirable that the user carry a supply of nail coils on his person, for example, when on a rooftop or the like. This invention supplies a support device for containing a plurality of nail coils supported by a user's utility belt.

Typically, builders will carry around nails while working so they are accessible when needed. Accessibility of the nails allows the builder to avoid constantly going back and forth to the tool kit, truck, or wherever else the original supply of nails are stored. Oftentimes, builders will carry the nails in their pockets. However, the nails can cause discomfort while stored in the pocket and they may pose a risk of injury if they poke through the pocket and into the user's skin. These risks increase especially when working with nail coils or strips which are oftentimes, simply too large and cumbersome to fit into a pocket. Further, the protruding nails inevitably bite into the fabric, making removal quite difficult. Thus, there remains a significant need for a nail coil holder that attaches to a belt and holsters the nail coils, thereby providing easy accessibility to them while performing construction work. Accordingly, the fast and ready access to spare nail coils is essential for efficient working with a nail gun.

Thus, it is necessary for users to have a device that can retain and store multiple nail coils for subsequent use in a nail gun. Further, there is a need in the art for a device that can be secured to a user's tool belt for ease in transporting multiple nail coils. Accordingly, the disclosed device allows multiple nail coils to be stacked vertically within a tube structure, thereby ensuring that the nail coils are safely stored and remain easily accessible.

Therefore, there exists a long-felt need in the art for a roofing nail coil holder device that provides users with a cylindrical storage system for nail coils. There is also a long-felt need in the art for a roofing nail coil holder device that allows users to store eight to ten coils of nail coils inside the tube and easily access the coils at any given time to reload a nail gun. Further, there is a long-felt need in the art for a roofing nail coil holder device that includes a clip on the near side to firmly secure the tube to a toolbelt for convenient access. Moreover, there is a long-felt need in the art for a device that maintains the nail coils in a vertical orientation such that the top-most nail coil can be easily pulled out of the tube. Further, there is a long-felt need in the art for a roofing nail coil holder device that saves extensive time and effort on a worksite where employees are utilizing a nail gun, allowing for more nail coils to be brought with them on a specific task. Finally, there is a long-felt need in the art for a roofing nail coil holder device that provides workplace safety and organization, while ensuring easy accessibility of nail coils.

The subject matter disclosed and claimed herein, in one embodiment thereof, comprises a roofing nail coil holder device. The device is a plastic storage device designed to store nail coils for nail guns. The device comprises a tubular housing component that can store eight to ten rolls of nail coils simultaneously, which greatly aids workplace safety and organization. Further, the front of the tubular housing component comprises a thin slot, allowing users to easily pull nail coils from the device for reloading them into the nail gun. The nail coils will be stacked vertically within the tubular housing component, thereby ensuring that the nail coils are safely stored and remain easily accessible. Thus, users can clip the tubular housing component onto their toolbelt via a clip and pull nail coils from the tubular housing component as needed while working.

In this manner, the roofing nail coil holder device of the present invention accomplishes all of the foregoing objectives and provides users with a device that saves extensive time and effort on a worksite where employees are utilizing a nail gun. The device provides users with workplace safety and organization and ensures that the nail coils are safely stored and easily accessible. The device fits most standard nail coils and is securable to a user's toolbelt via a clip.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a roofing nail coil holder device. The device is a storage device designed to store nail coils for nail guns. The device comprises a tubular housing component that can store eight to ten rolls of nail coils simultaneously. Further, the device allows users to easily pull nail coils from the device for reloading them into a nail gun. The nail coils will be stacked vertically within the tubular housing component, thereby ensuring that the nail coils are safely stored and remain easily accessible. Thus, users can pull nail coils from the tubular housing component as needed while working.

In one embodiment, the roofing nail coil holder device comprises a tubular housing component. The housing component does not have to be tubular in shape but can be any suitable shape as is known in the art, such as rectangular, square, oval, etc., depending on the needs and/or wants of a user. Generally, the housing component can be any suitable size and shape, as long as the housing component can house multiple nail coils. Furthermore, the housing component typically houses the multiple nail coils in a vertical position, allowing the nail coils to be stacked one on top of each other. However, in another embodiment, the nail coils can be stored in a horizontal position within the housing component.

In one embodiment, the housing component comprises a front surface, a rear surface, a top opening, and a base or bottom surface. Furthermore, the housing component of the roofing nail coil holder device is approximately 3″ to 5″ wide and 3″ to 4″ long, such that it can hold an average-sized nail coil. In a preferred embodiment, the roofing nail coil holder device may be integrally molded, and in this regard the dimensions are fixed. However, the relative dimensions may be varied to fit nail coils of any desired length and width. Thus, it is envisioned that different models of the roofing nail coil holder device will be made available for differently sized nail coils.

In one embodiment, the housing component has a flat base with vertical sides extending upward from the base, creating a cylindrical shape with an open interior cavity. The flat base is especially useful in placing the housing component down on a surface to load/unload nail coils or simply rest as a freestanding holder. The vertical sides extend upward a suitable length, generally long enough to house eight to ten rolls of nail coils in a stacked position within the housing cavity. The degree of roundedness and/or the cylindrical shape of the housing component loosely conforms to the shape of the nail coils.

In another embodiment, the housing component has an open top so the nail coils can be inserted therethrough and such that the user has access to the interior cavity. Further, the front of the housing component comprises a thin slot that extends from the top of the housing component partially down the length of the housing component. The slot can be any suitable width as is known in the art, as long as nail coils can be easily removed via the slot. Typically, the slot is approximately 1″ to 3″ wide. The slot allows users to easily pull nail coils from the housing component for reloading the nail coils in a nail gun. The slot also allows for easier insertion of the nail coils, allowing a user to easily stack the nail coils within the housing component.

In one embodiment, the roofing nail coil holder device is shown with a nail coil being held within the housing component. The nail coil comprises a plurality of nails all extending parallel to each other, evenly spaced along and connected by a linear carrier, and rolled into a spiral having a central void. Some of the nails are visible through the slot. The nails conventionally have a point on one end and a head on an opposite end. Preferably, the nails are positioned such that the points are oriented toward the bottom or base of the housing component. Accordingly, even the nails which are exposed through the slot cannot harm the user. The present invention therefore allows the nail coils to be stored in the housing component until needed, and then retrieved by inserting one's fingers through the slot in the housing component's front surface into the central void of the nail coil, lifting the nail coil upward, and removing the nail coil out the top opening of the housing component.

In one embodiment, the tubular housing component comprises a belt clip or other suitable securing means as is known in the art, such as a snap, a bolt, a strap, etc., depending on the needs and/or wants of a user. The belt clip is secured to the rear of the housing component via any suitable securing means as is known in the art, such as gluing, adhesive, screws, bolts, etc. The belt clip allows the device to be secured to a user's toolbelt during use. Specifically, the belt clip allows for attachment of the housing component to a belt worn by a user. The belt clip can be composed of a variety of materials, including for example, hard and soft metals, such as aluminum and stainless steel, hard plastics, flexible plastics, or combinations thereof, such as a metal clip having a plastic sheath.

In one embodiment, the housing component comprises at least one slot to be cut out of the bottom (or base) of the housing component to allow water and/or debris to drain out of the housing component, thereby allowing the nail coils to be free and clear of any material that may invite rust or obstruct construction in any other way.

In another embodiment, the open top of the housing component comprises a strap which may be looped over the open top and secured to an attachment point on the opposite side of the open top of the housing component to prevent the plurality of nail coils from inadvertently falling out of the device during the activities of the user. In another embodiment, the open top of the housing component comprises a lid or other securing feature as is known in the art, which can be releasably secured to the housing component. The lid secures the nail coils within the housing component and allows a user access to the nail coils when needed.

In one embodiment, the roofing nail coil holder device is preferably fabricated from polypropylene, polycarbonate, or other flexible, resilient, commercially available plastic, or lightweight metals, such as aluminum, steel, etc. Further, the device may be integrally molded. One skilled in the art will understand that any material possessing an appropriate amount of flexibility and resiliency may be used, and other suitable manufacturing methods may be employed such as an injection molding process.

In yet another embodiment, the roofing nail coil holder device comprises a plurality of indicia.

In operation of the roofing nail coil holder device, the housing component is supported on a user's toolbelt via a belt clip. One or more coils of nails are then vertically positioned within the housing component to be successively removed therefrom via a slot, as needed for loading a power nail gun.

As is evident from the above disclosure, the roofing nail coil holder devices of the present invention possess a simple, yet scalable, design that may be economically manufactured and sold to provide for widespread use. The device utilizes lightweight materials chosen to provide the appropriate degree of flexibility, resiliency, durability, and longevity required by the nature of its usage, and yet its cost is minimal to allow ready disposal.

The devices are very easily accessible while working because they attach to a belt and thus, they provide a great deal of convenience. The roofing nail coil holder devices are a very convenient storage medium for nail coils even when the devices are not attached to the belt.

In yet another embodiment, a method of storing a plurality of nail coils for use on a toolbelt is described. The method includes the steps of providing a roofing nail coil holder device comprising a tubular housing component for storing a plurality of nail coils, wherein the tubular housing component comprises a slot and a belt clip. The method also comprises placing eight to ten nail coils within the tubular housing component in a stacked, vertical position. Further, the method comprises securing the device to a user's toolbelt via the belt clip on the tubular housing component. Finally, removing a nail coil as needed via a user pulling the nail coil from the device via the slot.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the roofing nail coil holder device of the present invention in use in accordance with the disclosed architecture;

FIG. 2 illustrates a perspective view of one embodiment of the roofing nail coil holder device of the present invention showing how the nail coils are inserted into the housing in accordance with the disclosed architecture;

FIG. 3 illustrates a perspective view of one embodiment of the roofing nail coil holder device of the present invention wherein the device is secured to a toolbelt via a clip in accordance with the disclosed architecture;

FIG. 4 illustrates a perspective view of one embodiment of the roofing nail coil holder device of the present invention showing front and rear views of the tubular housing component in accordance with the disclosed architecture;

FIG. 5 illustrates a perspective view of one embodiment of the roofing nail coil holder device of the present invention showing how the clip is applied to a toolbelt in accordance with the disclosed architecture; and

FIG. 6 illustrates a flowchart showing the method of storing a plurality of nail coils for use on a toolbelt in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a roofing nail coil holder device that provides users with a cylindrical storage system for nail coils. There is also a long-felt need in the art for a roofing nail coil holder device that allows users to store eight to ten coils of nail coils inside the tube and easily access the coils at any given time to reload a nail gun. Further, there is a long-felt need in the art for a roofing nail coil holder device that includes a clip on the near side to firmly secure the tube to a toolbelt for convenient access. Moreover, there is a long-felt need in the art for a device that maintains the nail coils in a vertical orientation such that the top-most nail coil can be easily pulled out of the tube. Further, there is a long-felt need in the art for a roofing nail coil holder device that saves extensive time and effort on a worksite where employees are utilizing a nail gun, allowing for more nail coils to be brought with them on a specific task. Finally, there is a long-felt need in the art for a roofing nail coil holder device that provides workplace safety and organization, while ensuring easy accessibility of nail coils.

The present invention, in one exemplary embodiment, is a novel roofing nail coil holder device. The device is a storage device designed to store nail coils for nail guns. The device comprises a tubular housing component that can store eight to ten rolls of nail coils simultaneously. Further, the front of the tubular housing component comprises a thin slot, allowing users to easily pull nail coils from the device for reloading them into the nail gun. The nail coils will be stacked vertically within the tubular housing component, thereby ensuring that the nail coils are safely stored and remain easily accessible. The rear of the tubular housing component comprises a clip that allows the tubular housing component to be secured to a user's toolbelt for easy transportation. The present invention also includes a novel method of storing a plurality of nail coils for use on a toolbelt. The method includes the steps of providing a roofing nail coil holder device comprising a tubular housing component for storing a plurality of nail coils, wherein the tubular housing component comprises a slot and a clip. The method also comprises placing eight to ten nail coils within the tubular housing component in a vertical position. Further, the method comprises securing the device to a user's toolbelt via the clip on the tubular housing component. Finally, removing a nail coil as needed via a user pulling the nail coil from the device via the slot.

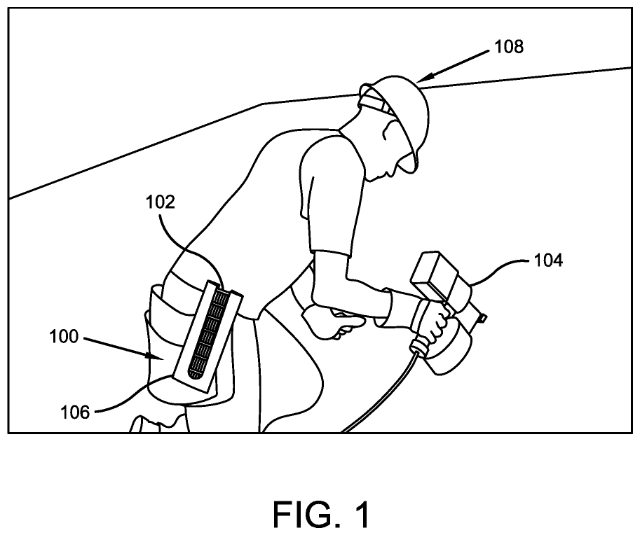

Referring initially to the drawings, FIG. 1 illustrates a perspective view of one embodiment of the roofing nail coil holder device 100 of the present invention. In the present embodiment, the roofing nail coil holder device 100 is an improved roofing nail coil holder device 100 that greatly aids workplace safety and organization. The device 100 is a storage device designed to store nail coils 102 for nail guns 104. The roofing nail coil holder device 100 further comprises a housing component 106 that can store eight to ten rolls of nail coils 102 simultaneously. Further, the device 100 allows users 108 to easily pull nail coils 102 from the device 100 for reloading them into a nail gun 104. The nail coils 102 will be stacked vertically within the housing component 106, thereby ensuring that the nail coils 102 are safely stored and easily accessible. Thus, users 108 can pull nail coils 102 from the housing component 106 as needed while working.

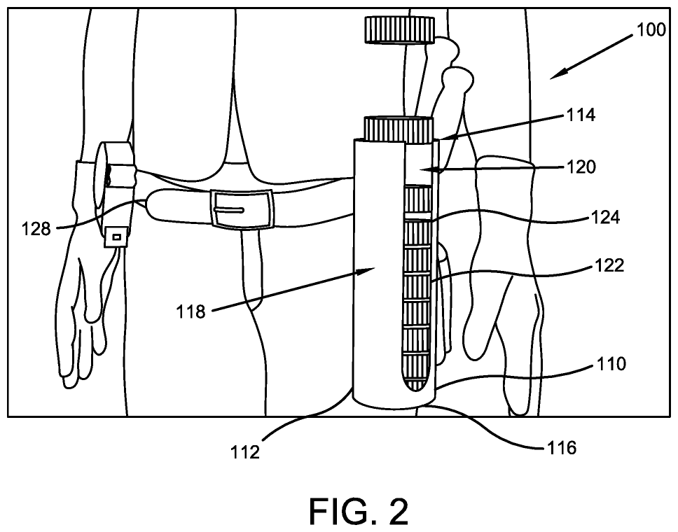

As shown in FIG. 2, the roofing nail coil holder device 100 comprises a tubular housing component 106. The housing component 106 does not have to be tubular in shape but can be any suitable shape as is known in the art, such as rectangular, square, oval, etc., depending on the needs and/or wants of a user. Generally, the housing component 106 can be any suitable size and shape, as long as the housing component 106 can house multiple nail coils 102. Furthermore, the housing component 106 typically houses the multiple nail coils 102 in a vertical position, allowing the nail coils 102 to be stacked one on top of each other. However, in another embodiment, the nail coils 102 can be stored in a horizontal position within the housing component 106.

Additionally, the housing component 106 comprises a front surface 110, a rear surface 112, a top opening 114, and a base or bottom surface 116. Furthermore, the housing component 106 of the roofing nail coil holder device 100 is approximately 3″ to 5″ wide and 3″ to 4″ long, such that it can hold an average-sized nail coil 102. In a preferred embodiment, the roofing nail coil holder device 100 may be integrally molded, and in this regard the dimensions are fixed. However, the relative dimensions may be varied to fit nail coils 102 of any desired length and width. Thus, it is envisioned that different models of the roofing nail coil holder device 100 will be made available for differently sized nail coils 102.

Typically, the housing component 106 has a flat base 116 with vertical sides 118 extending upward from the base 116, creating a cylindrical shape with an open interior cavity 120. The flat base 116 is especially useful in placing the housing component 106 down on a surface to load/unload nail coils 102 or simply rest as a freestanding holder. The vertical sides 118 extend upward a suitable length, generally long enough to house eight to ten rolls of nail coils 102 in a stacked position within the housing cavity 120. The degree of roundedness and/or the cylindrical shape of the housing component 106 loosely conforms to the shape of the nail coils 102.

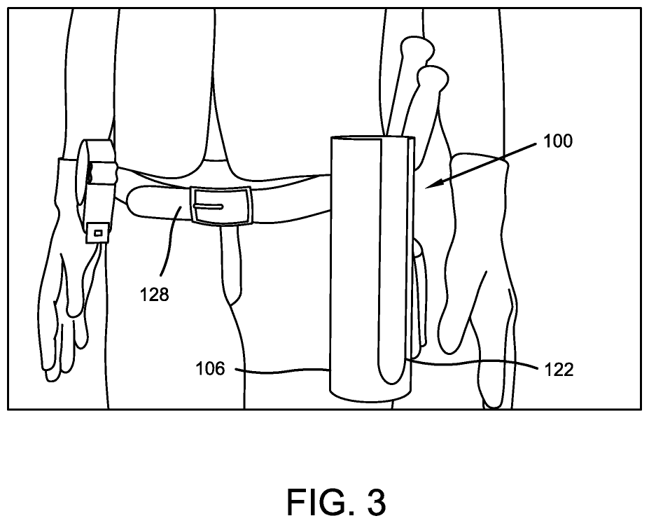

As shown in FIG. 3, the housing component 106 comprises an open top 114 so the nail coils 102 can be inserted therethrough and such that the user 108 has access to the interior cavity 120. Further, the front surface 110 of the housing component 106 comprises a thin slot 122 that extends from the top 114 of the housing component 106 partially down the length of the housing component 106. The slot 122 can be any suitable width as is known in the art, as long as nail coils 102 can be easily removed via the slot 122. Typically, the slot 122 is approximately 1″ to 3″ wide. The slot 122 allows users 108 to easily pull nail coils 102 from the housing component 106 for reloading the nail coils 102 in a nail gun 104. The slot 122 also allows for easier insertion of the nail coils 102, allowing a user 108 to easily stack the nail coils 102 within the housing component 106 for use.

Additionally, the roofing nail coil holder device 100 is shown with a nail coil 102 being held within the housing component 106. The nail coil 102 comprises a plurality of nails 124 all extending parallel to each other, evenly spaced along and connected by a linear carrier, and rolled into a spiral having a central void. Some of the nails 124 are visible through the slot 122. The nails 124 conventionally have a point on one end and a head on an opposite end. Preferably, the nails 124 are positioned such that the points are oriented toward the bottom or base 116 of the housing component 106. Accordingly, even the nails 124 which are exposed through the slot 122 cannot harm the user 108. The present invention therefore allows the nail coils 102 to be stored in the housing component 106 until needed, and then retrieved by inserting one's fingers through the slot 122 in the housing component's front surface 110 into the central void of the nail coil 102, lifting the nail coil 102 upward, and removing the nail coil 102 out the top opening 120 of the housing component 106.

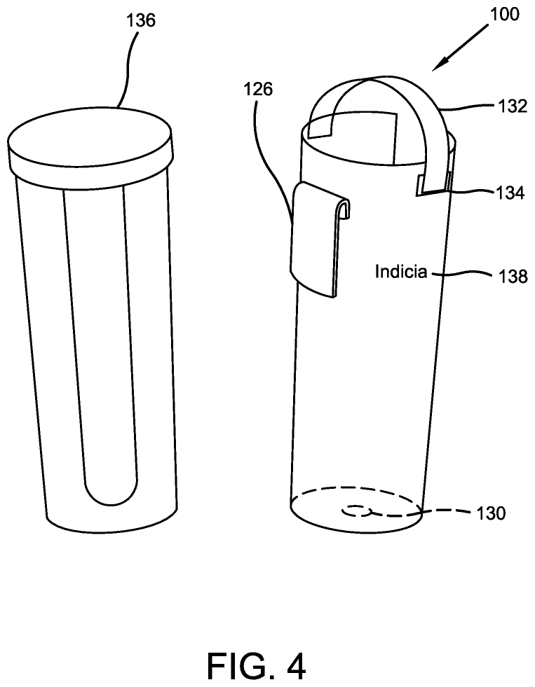

As shown in FIG. 4, the tubular housing component 106 comprises a belt clip 126 or other suitable securing means as is known in the art, such as a snap, a bolt, a strap, etc., depending on the needs and/or wants of a user. The belt clip 126 is secured to the rear surface 112 of the housing component 106 via any suitable securing means as is known in the art, such as gluing, adhesive, screws, bolts, etc. The belt clip 126 allows the device 100 to be secured to a user's toolbelt 128 during use. Specifically, the belt clip 126 allows for attachment of the housing component 106 to a belt 128 worn by a user 108. The belt clip 126 can be composed of a variety of materials, including for example, hard and soft metals, such as aluminum and stainless steel, hard plastics, flexible plastics, or combinations thereof, such as a metal clip having a plastic sheath, or any other suitable materials as is known in the art.

In one embodiment, the housing component 106 comprises at least one slot 130 to be cut out of the bottom (or base 116) of the housing component 106 to allow water and/or debris to drain out of the housing component 106, thereby allowing the nail coils 102 to be free and clear of any material that may invite rust or obstruct construction in any other way. Any suitable number of slots 130 can be utilized as is known in the art, depending on the needs and/or wants of a user.

In another embodiment, the open top 114 of the housing component 106 comprises a strap 132 which may be looped over the open top 114 and secured to an attachment point 134 on the opposite side of the open top 114 of the housing component 106 to prevent the plurality of nail coils 102 from inadvertently falling out of the device 100 during the activities of the user 108. In another embodiment, the open top 114 of the housing component 106 comprises a lid 136 or other securing feature as is known in the art, which can be releasably secured to the housing component 106. The lid 136 secures the nail coils 102 within the housing component 106 and allows a user 108 access to the nail coils 102 when needed. Any suitable lid 136 as is known in the art can be utilized, depending on the needs and/or wants of a user.

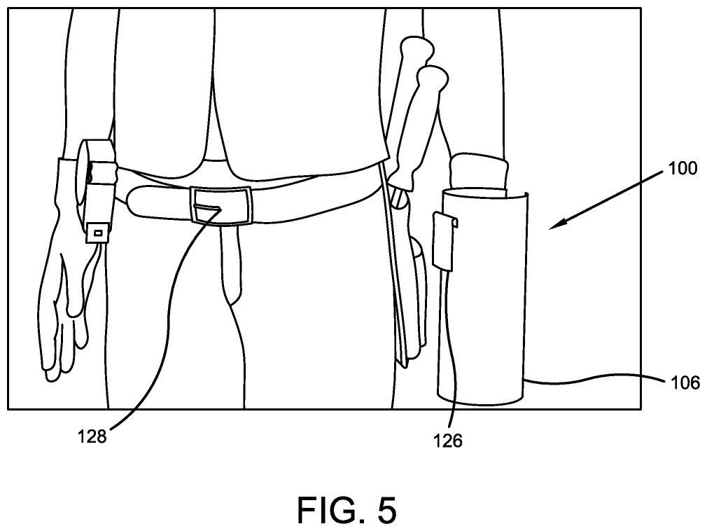

As shown in FIG. 5, the roofing nail coil holder device 100 is preferably fabricated from heat-sealable plastic or polymers, such as polypropylene or acrylonitrile-butadiene-styrene (ABS), or any other suitable material as is known in the art, such as but not limited to, acrylic, polycarbonate, polyethylene, thermoplastics, polyethylene terephthalate, polyvinyl chloride, polystyrene, polylactic acid, or lightweight metals, such as aluminum, steel, etc. Further, the device 100 may be integrally molded. One skilled in the art will understand that any material possessing an appropriate amount of flexibility and resiliency may be used, and other suitable manufacturing methods may be employed such as an injection molding process. Additionally, the roofing nail coil holder device 100 is also manufactured from a material that is water resistant or waterproof, or the housing component 106 comprises a coating that is water resistant or waterproof.

Furthermore, the roofing nail coil holder device 100 comprises a plurality of indicia 138. The housing component 106 of the device 100 may include advertising, a trademark, or other letters, designs, or characters, printed, painted, stamped, or integrated into the housing component 106, or any other indicia 138 as is known in the art. Specifically, any suitable indicia 138 as is known in the art can be included, such as but not limited to, patterns, logos, emblems, images, symbols, designs, letters, words, characters, animals, advertisements, brands, etc., that may or may not be nail gun or nail coil/brand related.

In operation of the roofing nail coil holder device 100, the housing component 106 is supported on a user's toolbelt 128 via a belt clip 126. One or more coils of nails 102 are then vertically positioned within the housing component 106 to be successively removed therefrom via a slot 130, as needed for loading a power nail gun 104.

As is evident from the above disclosure, the roofing nail coil holder devices 100 of the present invention possess a simple, yet scalable, design that may be economically manufactured and sold to provide for widespread use. The device 100 utilizes lightweight materials chosen to provide the appropriate degree of flexibility, resiliency, durability, and longevity required by the nature of its usage, and yet its cost is minimal to allow ready disposal.

The device 100 is very easily accessible while working because it attaches to a belt 128 and thus, provides a great deal of convenience. The roofing nail coil holder device 100 is a very convenient storage medium for nail coils 102 even when the device 100 is not attached to the belt 128.

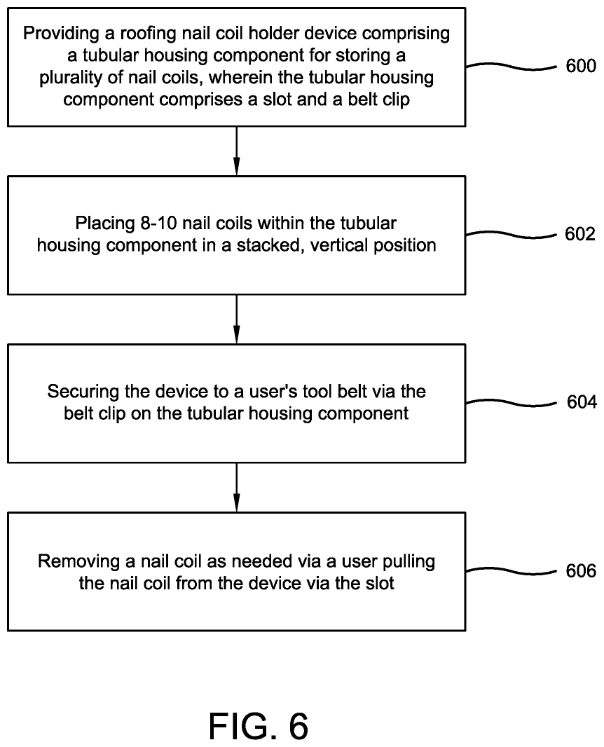

FIG. 6 illustrates a flowchart of the method of storing a plurality of nail coils for use on a toolbelt. The method includes the steps of at 600, providing a roofing nail coil holder device comprising a tubular housing component for storing a plurality of nail coils, wherein the tubular housing component comprises a slot and a belt clip. The slot is positioned on a front surface and allows for easy insertion and removal of the nail coils and the belt clip is positioned on a rear surface and secures the device to a user's belt. The method also comprises at 602, placing eight to ten nail coils within the tubular housing component in a stacked, vertical position. The nail coils are positioned one on top of the other within the housing component. Further, the method comprises at 604, securing the device to a user's toolbelt via the belt clip on the tubular housing component. The device can be secured to a user's toolbelt or belt, depending on the needs and/or wants of a user. Finally, at 606, removing a nail coil as needed via a user pulling the nail coil from the device via the slot.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “roofing nail coil holder device”, “holder device”, and “device” are interchangeable and refer to the roofing nail coil holder device 100 of the present invention.

Notwithstanding the foregoing, the roofing nail coil holder device 100 of the present invention can be of any suitable size and configuration as is known in the art without affecting the overall concept of the invention, provided that it accomplishes the above-stated objectives. One of ordinary skill in the art will appreciate that the roofing nail coil holder device 100 as shown in FIGS. 1-6 are for illustrative purposes only, and that many other sizes and shapes of the roofing nail coil holder device 100 are well within the scope of the present disclosure. Although the dimensions of the roofing nail coil holder device 100 are important design parameters for user convenience, the roofing nail coil holder device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A roofing nail coil holder device for ensuring that nail coils are safely stored and easily accessible, the roofing nail coil holder device comprising:
a housing component; and
a plurality of nail coils stacked vertically within the housing component;
wherein a user pulls at least one of the plurality of nail coils from the housing component as needed while working;
wherein the housing component comprises a flat base with vertical sides extending upward from the flat base, creating a cylindrical shape with an open interior cavity; and
further wherein the cylindrical shape loosely conforms to shape of the plurality of nail coils.

2. The roofing nail coil holder device of claim 1, wherein the vertical sides of the housing component comprise a front surface and a rear surface.

3. The roofing nail coil holder device of claim 2, wherein the housing component comprises a top opening for inserting the plurality of nail coils into the open interior cavity of the housing component.

4. The roofing nail coil holder device of claim 3, wherein the flat base allows the housing component to be placed on a surface for loading or unloading the plurality of nail coils.

5. The roofing nail coil holder device of claim 4, wherein the housing component comprises a slot on the front surface for easy removal of the plurality of nail coils.

6. The roofing nail coil holder device of claim 5, wherein the slot extends from the top opening partially down a length of the housing component.

7. The roofing nail coil holder device of claim 6, wherein the plurality of nail coils are inserted into the housing component such that nail tips from the plurality of nail coils are oriented toward the flat base of the housing component.

8. The roofing nail coil holder device of claim 7, wherein the housing component comprises a belt clip for securing the housing component to a user's belt.

9. The roofing nail coil holder device of claim 8, wherein the flat base of the housing component comprises at least one slot cut out to allow water and debris to drain out of the housing component.

10. The roofing nail coil holder device of claim 9, wherein the top opening of the housing component comprises a strap which is looped over the top opening and secured to an attachment point on an opposite side of the top opening.

11. The roofing nail coil holder device of claim 9, wherein the top opening of the housing comprises a removable lid.

12. The roofing nail coil holder device of claim 9 further comprising a plurality of indicia.

13. A roofing nail coil holder device for ensuring that nail coils are safely stored and easily accessible, the roofing nail coil holder device comprising:
a housing component comprising a flat base with vertical sides extending upward from the flat base, creating a cylindrical shape with an open interior cavity and a top opening;
wherein the cylindrical shape loosely conforms to shape of the plurality of nail coils;
wherein the vertical sides of the housing component comprise a front surface and a rear surface;
wherein a plurality of nail coils are stacked vertically within the housing component;
wherein users pull at least one of the plurality of nail coils from the housing component as needed while working; and
further wherein the housing component comprises a slot on the front surface for easy removal of the plurality of nail coils.

14. The roofing nail coil holder device of claim 13, wherein the housing component comprises a belt clip for securing the housing component to a user's belt.

15. The roofing nail coil holder device of claim 13, wherein the flat base of the housing component comprises at least one slot cut out to allow water and debris to drain out of the housing component.

16. The roofing nail coil holder device of claim 13 further comprising a plurality of indicia.

17. The roofing nail coil holder device of claim 13, wherein the top opening of the housing component comprises a strap which is looped over the top opening and secured to an attachment point on an opposite side of the top opening.

18. The roofing nail coil holder device of claim 13, wherein the top opening of the housing comprises a removable lid.

19. The roofing nail coil holder device of claim 13, wherein the plurality of nail coils are inserted into the housing component such that nail tips from the plurality of nail coils are oriented toward the flat base of the housing component.

20. A method of storing a plurality of nail coils for use on a toolbelt, the method comprising the steps of:
providing a roofing nail coil holder device comprising a tubular housing component for storing a plurality of nail coils, wherein the tubular housing component comprises a slot and a belt clip;
placing eight to ten nail coils within the tubular housing component in a stacked, vertical position;
securing the roofing nail coil holder device to a user's toolbelt via the belt clip on the tubular housing component; and
removing a nail coil as needed via a user pulling the nail coil from the roofing nail coil holder device via the slot.
